(19) United States
(12) Patent Application Publication
(10) Pub. No.: US 2013/0218457 A1
(43) Pub. Date: Aug. 22, 2013

(54) CENTER APPARATUS AND NAVIGATION SYSTEM

(71) Applicant: DENSO CORPORATION, (US)

(72) Inventor: Shigehiro Mutoh, Anjo-city (JP)

(73) Assignee: DENSO CORPORATION, Kariya-city (JP)

(21) Appl. No.: 13/764,883

(22) Filed: Feb. 12, 2013

(30) Foreign Application Priority Data
Feb. 20, 2012 (JP) 2012-033946

(51) Int. Cl. G01C 21/34

(52) U.S. Cl. CPC G01C 21/34
USPC 701/420

(57) ABSTRACT

A center apparatus stores, in an associated manner, a special link passed by a navigation apparatus and a recommended route that would otherwise be traveled by the navigation apparatus if the navigation apparatus did not travel along the special link. The center apparatus may also receive a route search request from the navigation apparatus. Based on a start point and a destination provided in the route search request, the center apparatus calculates, as a searched route, a route between the start point and the destination. When the searched route calculated matches a recommended route stored in the center apparatus, the center apparatus calculates, as a special route, a route that includes the special link that is associated with the recommended route matching with the searched route, and transmits the special route to the navigation apparatus.

### CROSS REFERENCE TO RELATED APPLICATION

The present application is based on and claims the benefit of priority of Japanese Patent Application No. 2012-33946, filed on Feb. 20, 2012, the disclosure of which is incorporated herein by reference.

### TECHNICAL FIELD

The present disclosure generally relates to a center apparatus that searches for a route based on a current position and a destination acquired from a navigation apparatus, and a navigation system that has the center apparatus and the navigation apparatus.

### BACKGROUND

Conventional navigation apparatuses generally search for and output a route from a current position to a destination as a searched route that has, for example, a shortest travel time, a shortest travel distance, and/ora smallest fuel consumption. In addition, as provided in Japanese Patent Laid-Open No. 2011-17596 (JP '596) and Japanese Patent Laid-Open No. 2010-236938 (JP '938), a navigation apparatus searches and outputs a specific route that includes a specific link fulfilling a specific condition, such as good landscape, which is stored as map data.

However, the techniques disclosed in JP '596 and JP '938 must prepare, in the navigation apparatus, the map data of the specific link. In other words, when the specific link is not prepared as the map data, the specific link cannot be searched for and be provided as the specific route.

### SUMMARY

In an aspect of the present disclosure, a center apparatus and a navigation apparatus may be in communication with one another to form a navigation system. In particular, the center apparatus may receive a current position of the navigation apparatus via a current position acquisition unit. After receiving the current position, a passage determination unit of the center apparatus determines, based on a comparison between the current position of the navigation apparatus and map data stored in a map data storage device, whether the navigation apparatus has passed a special link that satisfies a specific condition.

The center apparatus may receive spot information from the navigation apparatus, which is determined to have passed the special link, via a spot information acquisition unit. The spot information received is information that identifies travel positions of the navigation apparatus before and after the passage of the special link, such as a start point and a destination.

A recommended route calculation unit of the center apparatus calculates, as a recommended route, a route that includes the travel positions before and after the passage of the special link and does not include the special link. The recommended route is calculated based on a comparison between the spot information that is acquired by the spot information acquisition unit and the map data stored in the map data storage device. The center apparatus than associates the special link with the recommended route via an association unit.

In such manner, the center apparatus can associate the special link that is passed by the navigation apparatus with the recommended route that would have otherwise been traveled by the navigation apparatus if the navigation apparatus did not pass the special link. In other words, the center apparatus can recognize the value of the special link that is commonly passed by an unspecified number of navigation apparatuses, assuming that the special link has an added value, such as a good view, which lures many vehicles at a cost of departing from the recommended route, which should have normally been passed.

Further, the center apparatus may receive a route search request from the navigation apparatus via a route search request acquisition unit. The route search request provides a start position (e.g., current position) and the destination of the navigation apparatus. A searched route calculation unit of the center apparatus then calculates, as a searched route, a route between the start position and the destination provided in the route search request, based on a comparison between the current position and the destination identified by the route search request.

A special route calculation unit calculates, as a special route, a route including a special link that is associated with the recommended route, based on a comparison between the searched route and the recommended route when it is determined that the searched route matches the recommended route. A special route presentation unit transmits the special route calculated by the special route calculation unit to the navigation apparatus that provided the route search request.

In such manner, when the center apparatus receives a route search request from the navigation apparatus, the center apparatus calculates a route identified by the request between the start point and the destination as a searched route. Upon determining that the searched route matches the recommended route, the center apparatus can present a route, which includes the special link that is associated with the recommended route matching the searched route, to the navigation apparatus as an special route. In other words, the center apparatus can present to the navigation apparatus the special route, which is commonly passed by an unspecified number of navigation apparatuses, assuming that such a link has an added value at a cost of departing from the recommended route.

As described above, instead of individually searching and outputting a special route by only one navigation apparatus, a cooperative search scheme is provided. In particular, the center apparatus searches for a special route to present to the navigation apparatus, and, thus, enabling the navigation apparatus to appropriately output the special route including the special link without elaborately preparing and storing information regarding the special link in the map data of the navigation apparatus.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of a navigation system of the present disclosure;

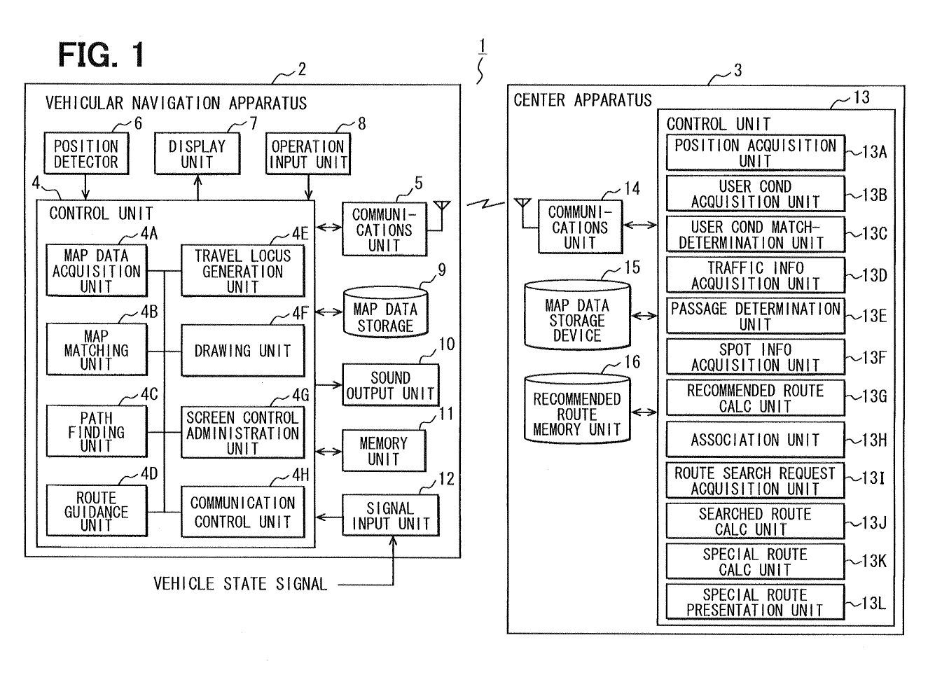

FIG. 2 is a flowchart of a recommended route association process performed by a center apparatus of the navigation system;

FIG. 3 is a flowchart of a special route presentation process performed by the center apparatus of the navigation system;

FIG. 4 is an illustration of a special link along a travel locus traveled by a navigation apparatus of the navigation apparatus system;

FIG. 5 is an illustration of the special link of FIG. 4 and a recommended route determined by the center apparatus of the navigation apparatus system;

FIG. 6 is an illustration of a searched route determined by the center apparatus of the navigation apparatus system;

FIG. 7 is an illustration of the special link of FIG. 4, the searched route of FIG. 6, the recommended route of FIG. 5, and a special route determined by the center apparatus Of the navigation apparatus system;

FIG. 8 is an illustration of a correspondence between the recommended route and the special link of FIG. 5;

FIG. 9 is an illustration of a route selection screen displayed by the navigation apparatus;

FIGS. 10, 11, 12, 13, 14, 15 are illustrations of an example in which multiple special links are associated with one recommended route;

FIGS. 16, 17, 18, 19, 20 are illustrations of an example in which one special link is associated with multiple recommended routes;

FIGS. 21, 22, 23, 24, 25 are illustrations of an example in which multiple special links are associated with multiple recommended routes; and

FIG. 26 is an illustration of a user condition setting screen.

### DETAILED DESCRIPTION

An embodiment of the present disclosure is described in the following with reference to the drawings.

A navigation system 1 includes a vehicular navigation apparatus 2 (i.e., a navigation apparatus 2 hereinafter) and a center apparatus 3, which are in communication with each other through a communication network. The correspondence between the navigation apparatus 2 and the center apparatus 3 is many to one, or, in other words, the center apparatus 3 communicates with multiple navigation apparatuses 2 (i.e., unspecified number of navigation apparatuses 2). The center apparatus 3 is configured to communicate with the navigation apparatuses 2 through the communication network.

The navigation apparatus 2 may be a device that is fixedly installed in a vehicle, or may be a device that is movably/removably used in the vehicle. The communication network may be a mobile communication network and/or a fixed communication network, including its infrastructure such as wireless base stations and telephone offices.

The navigation apparatus 2 includes a control unit 4, a communication unit 5, a position detector 6, a display unit 7, an operation input unit 8, a map data storage 9, a sound output unit 10, a memory unit 11, and a signal input unit 12.

The control unit 4 is provided as a well-known microcomputer including CPU, ROM, RAM, input/output (I/O) and the like, and controls an operation of the navigation apparatus 2. The communication unit 5 performs communication through the communication network with the center apparatus 3. The communication unit 5 may be, for example, a device that is provided separately from the navigation apparatus 2, such as a cellular phone.

The position detector 6 detects a current position of the vehicle (i.e., a current position of the navigation apparatus 2) by using, for example, a GPS sensor, an acceleration sensor, and a vehicle speed sensor. The position detector 6 may include only some of the sensors as long as it is capable of detecting the current position.

The display unit 7 includes a liquid crystal display device, and displays various screens, such as destination setting screens for setting a destination, map screens for displaying maps and navigating the driver. The operation input unit 8 includes switches for receiving an input operation of the user (i.e., vehicle occupant such as a driver). For instance the operation input unit 8 includes mechanical switches around the display unit 7 (e.g., push buttons on an upper part, a lower part, a right side and a left side of the display unit 7) and touch switches displayed on the screen of the display unit 7. The operation input unit 8 accepts only an easy operation when the vehicle is traveling (e.g., accepts only simple operations, consisting of a few steps), and does not accept other operations (e.g., does not accept complicated operations, having a large number of steps) for safety purposes.

The map data storage 9 has a recording medium, such as a hard disk, DVD, CD, and stores map data including road data, such as road shapes and attributes, and intersection data, such as traffic lanes and branch types. The map data stored in the map data storage 9 provides link information for identifying each of links in the map data.

The sound output unit 10 outputs various sounds and voices, such as driving guidance voices, and screen operation guidance voices, from a speaker.

The memory unit 11 includes, for example, ROM and RAM. The ROM in the memory unit 11 stores programs for various processing operations, such as a navigation program. The RAM of the memory unit 11 serves as a work memory for the execution of various programs, and/or has a temporary storage area for temporarily storing and expanding the map data that is acquired from the map data storage 9.

The signal input unit 12 receives a vehicle state signal indicative of various vehicle states from various ECUs and various sensors in the vehicle. More practically, the control unit 4 may receive, as the vehicle state signal from the signal input unit 12, an input of an ignition signal that indicates the ON/OFF of an ignition switch, for detecting a drive mechanism (i.e., engine) start/stop iming. The control unit 4 may determine, as a start point or a destination, a current position of the vehicle at a time of detecting the start or stop timing.

The control unit 4 controls each of the components in the navigation apparatus 2, and, according to well-known navigation functions, has the following units: a map data acquisition unit 4A, a map matching unit 4B, a path finding unit 4C, a route guidance unit 4D, a travel locus generation unit 4E, a drawing unit 4F, a screen control administration unit 4G, and a communication control unit 4H.

The map data acquisition unit 4A acquires map data stored in the map data storage 9. The map matching unit 4B identifies the current position of the vehicle detected by the position detector 6 as of which road the current position of the vehicle is located on, based on road data and the like in the map data that is acquired by the map data acquisition unit 4A from the map data storage 9.

The route search unit 4C searches for a route to a destination either from the current position of the vehicle or from a start point input by the user from the operation input unit 8. The route guidance unit 4D calculates what kinds of guidance (e.g., right/left turn instructions) and guidance points should be prepared for guiding the driver to the destination based on the road data and the intersection data in the map data as well as the search results from the route search unit 4C, and provides the calculated guidance as the vehicle travels along the route.

Based on the current position detected by the position detector 6, the travel locus generation unit 4E generates a travel locus of the vehicle on a map for displaying the locus on the display unit 7. The drawing unit 4F displays a screen image of the current position of the vehicle, a highway route map, and an expanded view of an intersection on the display unit 7, according to the instructions from the screen control administration unit 4G. The drawing unit 4F also displays on the display unit 7 the travel locus generated by the travel locus generation unit 4E. The communication control unit 4H controls a communication operation of the communication unit 5.

The center apparatus 3 has a control unit 13, a communication unit 14, a map data storage device 15 (i.e., a map data storage device in claims) and a recommended route memory unit 16. The control unit 13 is implemented as a well-known microcomputer having, for example, a CPU, ROM, RAM, input/output (I/O), and executes a control program for controlling an overall operation of the center apparatus 3. The communication unit 14 performs communication through the communication network with each of the navigation apparatuses 2.

The map data storage device 15 is a storage device, such as a hard disk, for storing computer readable data, and stores map data including the road data (i.e., road shapes and attributes) and intersection data (i.e., traffic lanes and branch types), which respectively correspond to the data stored in and processed by each of the navigation apparatuses 2, with some more details added thereon. The map data stored in the map data storage device 15 includes information that specifies that a certain link is a special link. The special link may be a scene-featured link having a magnificent view. For instance the special link may represent a route such as an over-the-bridge road or a coast line road. The special link may be a link that is prepared by a map data creating organization as such as featured link.

The control unit 13 includes as its functional units a current position acquisition unit 13A, a user condition acquisition unit 13B, a user condition match-determination unit 13C, a traffic information acquisition unit 13D, a passage determination unit 13E, a spot information acquisition unit 13F, a recommended route calculation unit 13G, an association unit 13H, a route search request acquisition unit 13I, a searched route calculation unit 13J, a special route calculation unit 13K, and a special route presentation unit 13L.

The current position acquisition unit 13A acquires a current position of the vehicle from the navigation apparatus 2, which is transmitted from the navigation apparatus 2 and is received by using the communication unit 14.

The user condition acquisition unit 13B acquires a user condition from the navigation apparatus 2, which is also transmitted from the navigation apparatus 2 and is received by the communication unit 14.

The user condition match-determination unit 130 determines whether a special route satisfies a user condition.

The traffic information acquisition unit 13D acquires, for example, traffic information regarding a traffic congestion and an accident, from a traffic information distribution server, which is received by the communication unit 14.

The passage determination unit 13E determines, based on a comparison between a current position of a vehicle acquired by the current position acquisition unit 13A and the map data stored in the map data storage device 15, whether a navigation apparatus 2 transmitting the current position of the vehicle has passed a special link. Specifically, the passage determination unit 13e determines whether the vehicle with the navigation apparatus 2 transmitting the current position of the vehicle has passed the special link.

The spot information acquisition unit 13F acquires spot information from the navigation apparatus 2, which is transmitted from the navigation apparatus 2 that is determined as having passed the special link by the passage determination unit 13E and is received by the communications unit 14.

The spot information is information that identifies travel positions of the vehicle before and after the passage of the special link, which has been identified by the navigation apparatus 2. The travel positions may be a start point, a destination, and the like.

The recommended route calculation unit 13G calculates, as a recommended route, a route that includes the travel positions before and after the passage of the special link and does not include the special link, based on a comparison between the spot information that is acquired by the spot information acquisition unit 13F and the map data stored in the map data storage device 15.

The association unit 13H stores the recommended route calculated by the recommended route calculation unit 13G and the special link stored in the map data, which is stored in the map data storage device 15, with an association established therebetween (i.e., between the recommended route and the special link).

The route search request acquisition unit 13I acquires a route search request from the navigation apparatus 2, which is transmitted from the navigation apparatus 2 and is received by the communication unit 14.

Based on a comparison between the current position and a destination identified by the route search request, which are acquired by the route search request unit 13I, and the map data stored in the map data storage device 15, the searched route calculation unit 13J calculates, as a searched route, a route from the current position to the destination respectively identified by the route search request.

The searched route calculation unit 13J calculates, as a searched route, a route between a current position and a destination, based on a comparison between the current position and the destination identified by the route search request acquired by the route search request acquisition unit 13I and the map data stored in the map data storage device 15.

The special route calculation unit 13K calculates, as a special route, a route including a special link that is associated with the recommended route, based on a comparison between the searched route calculated by the searched route calculation unit 13J and the recommended route stored in the recommended route memory unit 16, when it is determined that the searched route matches the recommended route.

The special route presentation unit 13I presents the special route to the navigation apparatus 2, which is calculated by the special route calculation unit 13K, by transmitting the special route from the communication unit 14 to the navigation apparatus 2.

In the navigation apparatus 2, the control unit 4 displays the special route on the display unit 7 when the special route is transmitted from the center apparatus 3 and received by the communication unit 5.

The operation of the system according to the above-described configuration is described in the following.

In the center apparatus 3, the control unit 13 periodically performs, in a scope of the present disclosure, a recommended route association process and a special route presentation process, which are explained one by one.

Each of the navigation apparatuses 2 that are in communication with the center apparatus 3 regularly transmit a current position of the vehicle in which it is disposed to the center apparatus 3, via the communication unit 5. The center apparatus 3 regularly receives the current position of multiple vehicles via the communication unit 14. In other words, each of the navigation apparatuses 2 serve as a probe apparatus (i.e., a probe vehicle) that regularly transmits a current position of the vehicle in which it is disposed to the center apparatus 3. The information regularly transmitted by the navigation apparatus 2 may also include a speed of the vehicle.

(1) Recommended Route Association Process

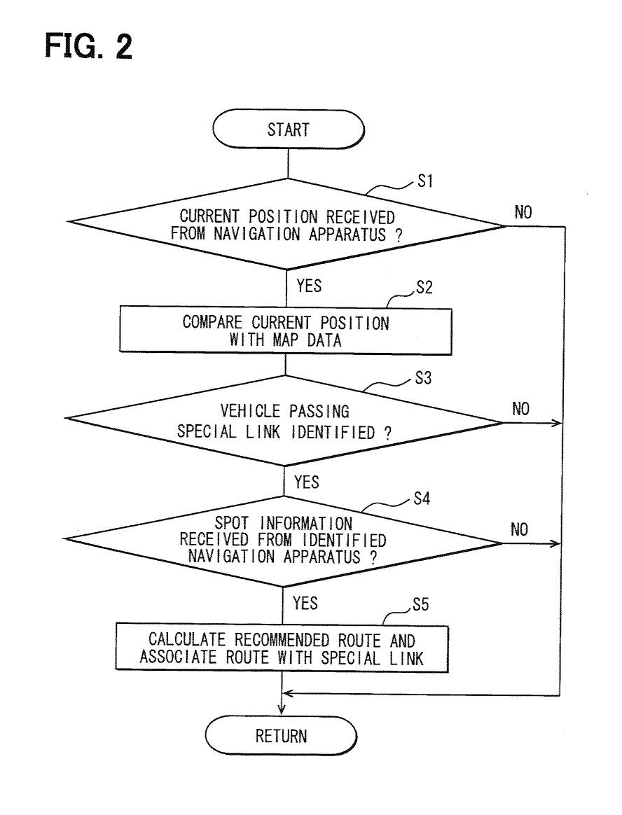

With reference to FIG. 2, the recommended route association process, which is performed by the control unit 13 of the center apparatus 3, is described. The control unit 13 determines whether it has received a current position of a vehicle transmitted from at least one of the multiple navigation apparatuses 2 via the communication unit 14 (S1). When the current position of a vehicle is received from each of the multiple navigation apparatuses 2 (S1:YES), the control unit 13 compares the current position received from many vehicles with the map data stored in the map data storage device 15 (S2). The control unit 13 then determines and identifies a subject vehicle that has passed a special link in the map data (S3).

When the current position of the subject vehicle is on the special link in the map data and the subject vehicle having passed the special link is identified (S3:YES), the control unit 13 transmits a spot information request to the navigation apparatus 2 disposed in the subject vehicle, which has passed the special link, to request spot information (a start point, a destination etc.) and waits for the spot information (S4).

If the ignition switch of the subject vehicle, which has the navigation apparatus 2 and has passed the special link, has not been turned off since the passing of the special link (i.e., if the travel of the subject vehicle has been continued uninterrupted after passing of the special link), the start point is recorded with the destination not yet recorded. If the ignition switch of the subject vehicle, which has the navigation apparatus 2 and has passed the special link, has already been turned off at least once since the passing of the special link (i.e., if the travel of the subject vehicle has not been uninterruptedly continued after passing of the special link), both of the start point and the destination is recorded.

Subsequently, when the control unit 13 determines that it has received the spot information transmitted from the navigation apparatus 2 (S4:YES), the control unit 13 compares the spot information received with the map data stored in the map data storage device 15, and calculates, as a recommended route, a route that includes the travel positions before and after the passage of the special link and does not include the special link (S5). The control unit 13 stores the recommended route calculated in the recommended route memory unit 16 in a referable manner, which enables the association between the special link and the recommended route calculated (S5) (i.e., which associated the special link with the recommended route calculated).

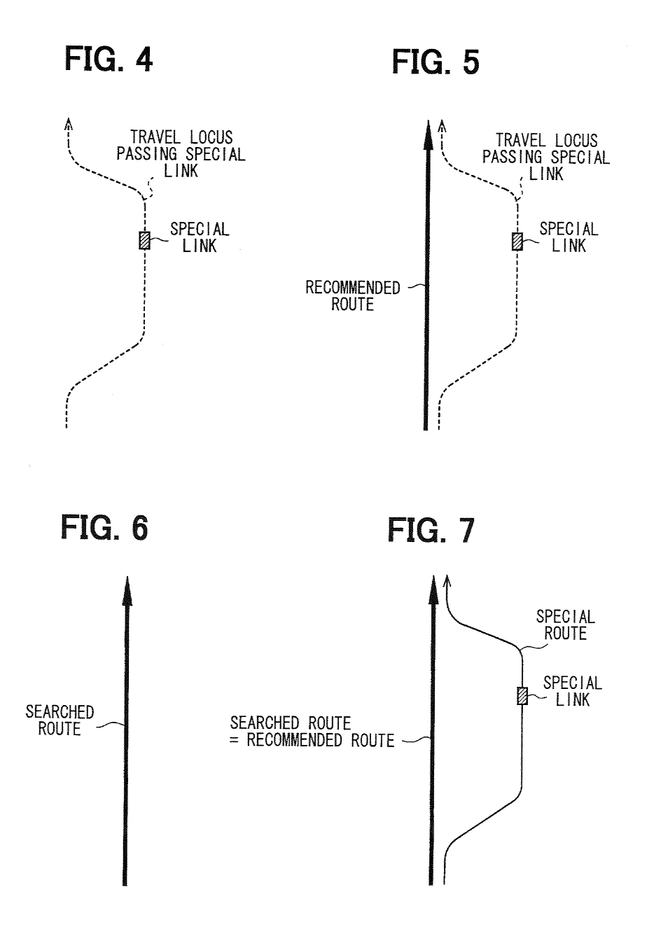

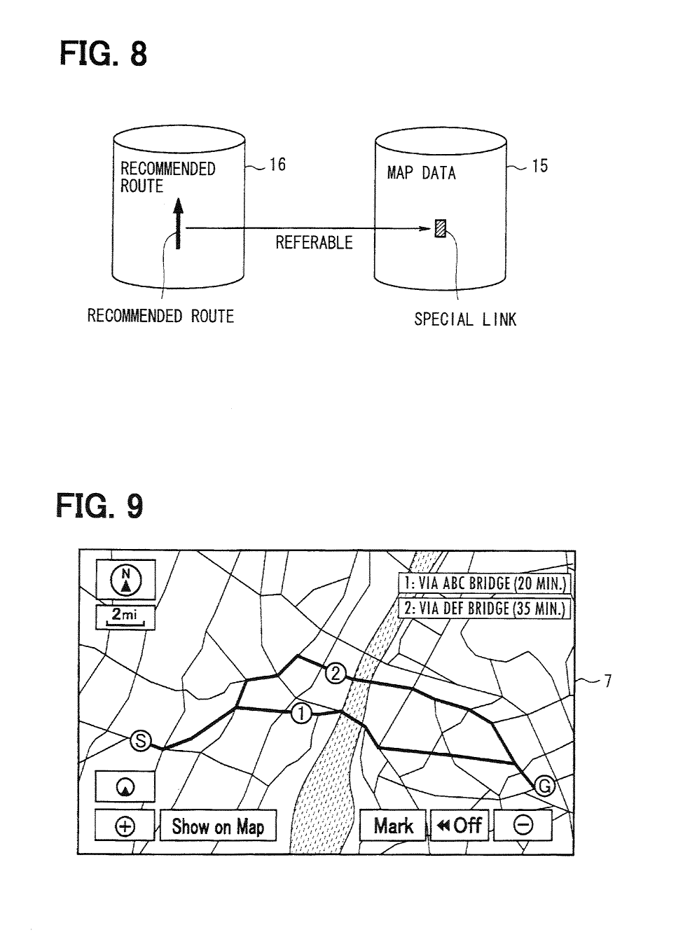

With reference to FIGS. 4 and 5, the center apparatus 3 regularly receives the current position of the vehicle from the multiple navigation apparatuses 2 (i.e., collects information from many probe vehicles). Next, the center apparatus 3 identifies the subject vehicle that has passed a special link, which is provided as a travel locus in FIG. 4. The center apparatus 3 then calculates the recommended route (FIG. 5) based on the spot information from the navigation apparatus 2 disposed in the subject vehicle that has passed the special link, and stores the recommended route calculated in a referable manner.

In particular the referable manner enables a reference from the recommended route calculated to the special link that is used as a basis of the calculation of the recommended route. Based on such association, the center apparatus 3 may determine or identify the special link that has been commonly passed by many navigation apparatuses 2 (i.e., probe vehicles). That is, the center apparatus 3 considers such special link as a valued link that is worth passing even by departing from the recommended route. Therefore, the center apparatus 3 can pick up and collect such recommended routes that should have otherwise been traveled.

(2) Special Route Presentation Process

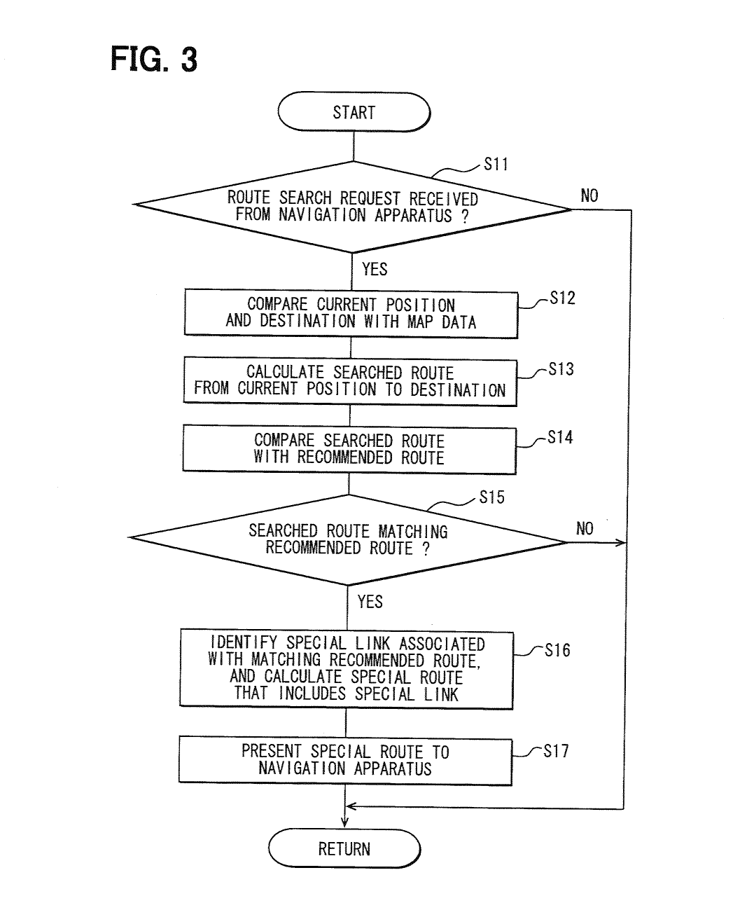

With reference to FIG. 3, the special route presentation process, which is performed by the control unit 13 of the center apparatus 3, is described. The control unit 13 determines whether it has received the route search request from the navigation apparatus 2 (S11). When the control unit 13 has received the route search request from the navigation apparatus 2 (S11:YES), the control unit 13 compares a start point and a destination identified by the route search request received with the map data stored in map data storage device 15 (S12), and calculates, as a searched route, a route from the start point to the destination (S13). On the other hand, if no route search request is received, the control unit 13 waits until one is received by returning to S11.

Subsequently, the control unit 13 compares the searched route calculated in S13 with the recommended routes stored in the recommended route memory unit 16 (S14), and determines whether the recommended route matches the searched route (S15). In particular, the control unit 13 determines that the recommended route matches the searched route when, for example, (i) a distance of one continuous common section between the recommended route and the searched route is equal to or greater than a preset value, or (ii) when a total distance of multiple common sections therebetween is equal to or greater than a preset value even when a distance of one continuous common section is not equal to or greater than a preset value.

Accordingly, when the recommended route matches the searched route (S15:YES), the control unit 13 searches the map data storage device 15 for a special link that is referred to by (i.e., associated with) the recommended route that matches the searched route, and calculates, as a special route, a route that includes the special link identified (S16). The control unit 13 transmits the special route calculated to the navigation apparatus 2 via the communication unit 14, and presents the special route to the navigation apparatus 2 (S17).

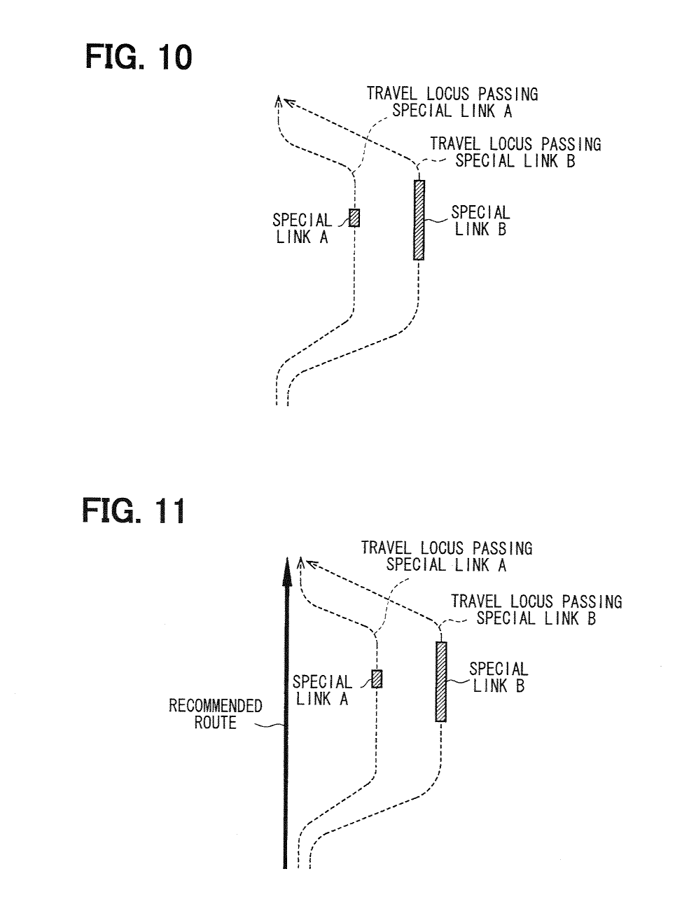

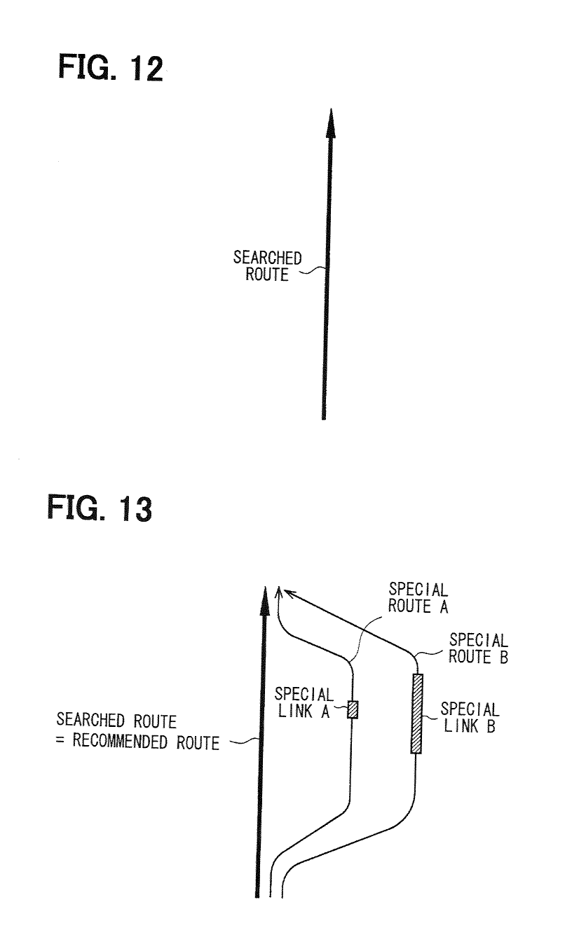

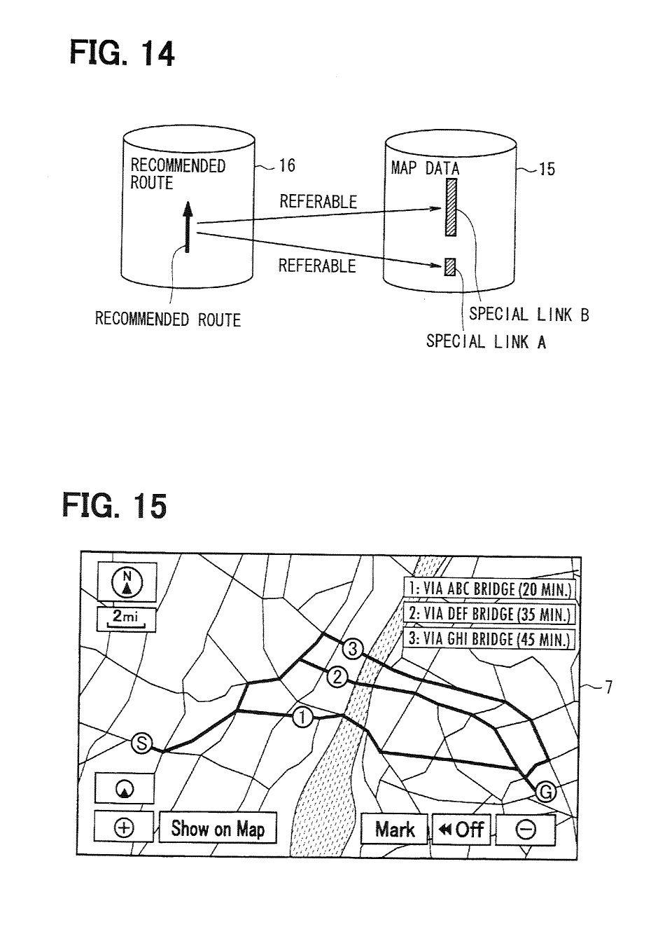

With reference to FIGS. 6 to 8, upon receiving a route search request from the navigation apparatus 2, the center apparatus 3 calculates a searched route based on the start point and the destination provided in the search request Upon determining that the searched route calculated matches the recommended route stored, the center apparatus 3 calculates a route that includes the special link that is referred to by the recommended route, which is matching with the searched route, and transmits the special route to the navigation apparatus 2 (FIGS. 7 and 8). Upon receiving the special route from the center apparatus 3, the navigation apparatus 2 displays the special route received together with the searched route that is searched for based on the start point and the destination by the navigation apparatus 2.

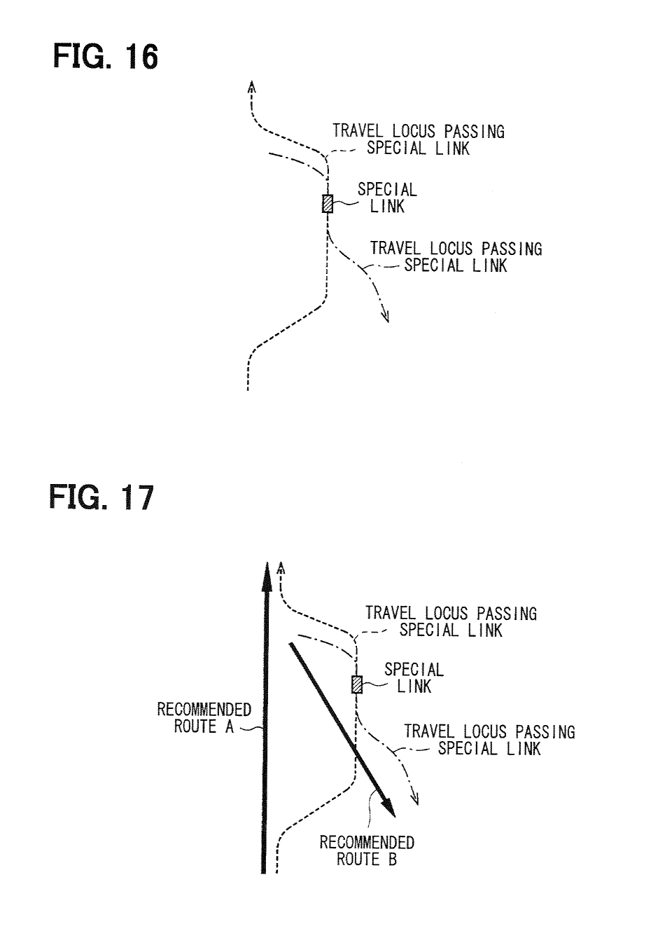

FIG. 9 illustrates a situation, in which the map data in the center apparatus 3 does not specify, as a special link, a link passing an ABC bridge, but specifies, as a special link, a link passing a DEF bridge that provides a better view than the ABC bridge.

By performing the recommended route association process, the center apparatus 3 calculates a route passing the ABC bridge (i.e., a first route) as a recommended route, when a link passing the DEF bridge has already been specified as a special link to which many probe vehicles have taken a detour route in order to pass the DEF bridge instead of the ABC bridge, which is on a shorter and less time-consuming route (i.e., information from those vehicles indicates such an “unnatural” detour of those vehicles).

Subsequently, by performing the special route presentation process, the center apparatus 3 calculates a route passing the ABC bridge as the searched route, which results in a match between the searched route and the recommended route. Next, a link passing the DEF bridge, which is associated with the recommended route, is identified as a special link. Therefore, the center apparatus 3 presents a route passing the DEF bridge (i.e., a second route) as a special route to the navigation apparatus 2.

The navigation apparatus 2 displays, in addition to displaying the first route, i.e., the searched route searched by the navigation apparatus 2 according to a normal search procedure (i.e., a procedure that searches for, for example, a shortest travel distance route, a shortest travel time route, and a smallest fuel consumption route), a special route, i.e., the second route, received from the center apparatus 3. The navigation apparatus 2 may distinguish between the first and second route by, for example, displaying the searched route and the special route in different colors.

The user may then choose from among selection candidates including a route with a better view and a desired route for receiving route guidance. In other words, when the user desires a normal route (i.e., a route having, for example, a shortest travel distance route, a shortest travel time route, and/or a smallest fuel consumption route), the user has the option to select the searched route, and, when the user desires a good view route, the user has the option to choose the special route.

Further, instead of displaying the searched route searched by the navigation apparatus 2 according to the normal search procedure, the navigation apparatus 2 may display a route that is searched and transmitted by the center apparatus 3 according to a normal search procedure. The navigation apparatus 2 may then display the searched routed transmitted from the center apparatus 3 and the special route that is also from the center apparatus 3.

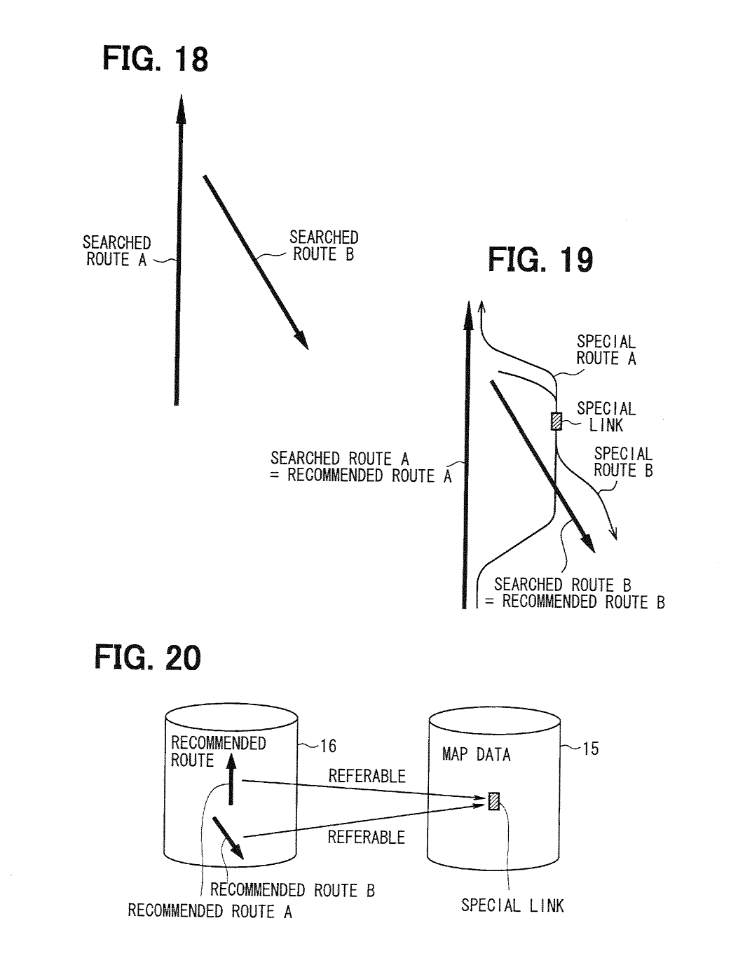

In the example, an association between the recommended route and the special link is described as a 1-to-1 correspondence, which may not always be the case. That is, an association therebetween may be a 1-to-many correspondence, associating one recommended route with multiple special links. In such a case, the recommended route association process, performed by the center apparatus 3, identifies, as shown in FIGS. 10 and 11, a vehicle that has passed either of a special link A or a special link B, and calculates a recommended route based on the spot information from the navigation apparatus 2 disposed in the vehicle that has passed either of the special link A or special link B. Subsequently, the center apparatus 3 stores the recommended route calculated in a referable manner that associates the recommended route calculated with the special links A and B that are used as a basis of the calculation of the recommended route.

Accordingly, per the special route presentation process, when the searched route matches the recommended route, the center apparatus 3 identifies, as shown in FIGS. 12 to 14, the special links A and B that are referred to by the recommended route, which is matching with the searched route. Therefore, a special route A, which is a route that includes the identified special link A, and a special route B, which is a route that includes the identified special link B, are calculated and transmitted to the navigation apparatus 2. The navigation apparatus 2 then display the special routes A and B, which were received from the center apparatus 3, together with the searched route that is searched by the navigation apparatus 2 based on the start point and the destination.

FIG. 15 illustrates a situation, in which the map data in the center apparatus 3 does not specify, as a special link, a link passing an ABC bridge, but specifies, as a special link, a link passing a DEF bridge and a link passing a GHI bridge respectively providing a better view than the ABC bridge.

By performing the recommended route association process, the center apparatus 3 calculates a route passing the ABC bridge (i.e., a first route) as a recommended route when a link passing the DEF bridge and/or GHI bridge has already been specified as a special link in which many probe vehicles have taken a detour route that passes either the DEF bridge or GHI bridge instead of the ABC bridge, which exists on a shorter and less time-consuming route. In other words, information from the probe vehicles indicates an unnatural detour collectively performed by the vehicles.

Subsequently, by performing the special route presentation process, the center apparatus 3 calculates a route passing the ABC bridge as the searched route, which results in a match between the searched route and the recommended route. The center apparatus then identifies two special links, a link passing the DEF bridge and a link passing the GHI bridge, which are associated with the recommended route. Therefore, the center apparatus 3 presents a route passing the DEF bridge (i.e., a second route) and a route passing the GHI bridge (i.e., a third route) as special routes to the navigation apparatus 2.

Note that the example described is a 1-to-2 association between the recommended route and the special links, however, the association may also be a 1-to-3 association or more between a recommended route and special links.

Further, an association between the recommended route and the special link may also be described as many-to-1 correspondence (i.e., multiple recommended routes to one special route).

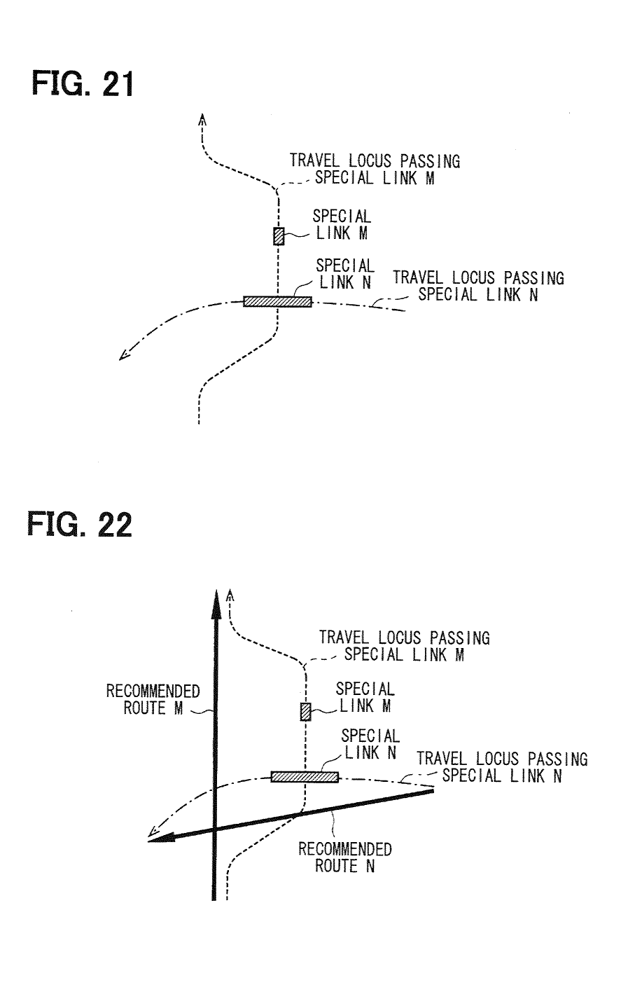

With reference to FIGS. 16 and 17, the center apparatus 3 identifies the vehicle, which has passed a special link, by the recommended route association process. The center apparatus 3 then calculates a recommended route A or a recommended route B based on the spot information of the navigation apparatus 2 that is disposed in the vehicle that has passed the special link. The recommended routes A and B are then stored with the special link (i.e., single special link) in a referable manner, which enables an association of the recommended routes A and B with the single special link that is used as a basis of the calculation of the recommended routes A and B.

With reference to FIGS. 18 to 20, the center apparatus 3 identifies, by the special route presentation process, the special link that is referred to by the recommended route A when a searched route A matches the recommended route A. A route that includes the special link identified is calculated as a special route A. When a searched route B matches the recommended route B, the center apparatus 3 identifies the special link, which was also associated with the recommended route A, and calculates, as a special route B, a route that includes the special link identified. After receiving the special route, which may be special route A or B depending on the searched route, from the center apparatus 3, the navigation apparatus 2 displays the special route A or B together with the searched route A or B, which was searched by the navigation apparatus 2 based on the start point and the destination.

Note that the above situation in the present embodiment, described as a 2-to-1 association between the recommended routes and the special link, may also be a 3-to-1 association or more between recommended routes and a special link.

An association described above between recommended routes and a special link may also be described as a many-to-many correspondence, substantially in the same manner.

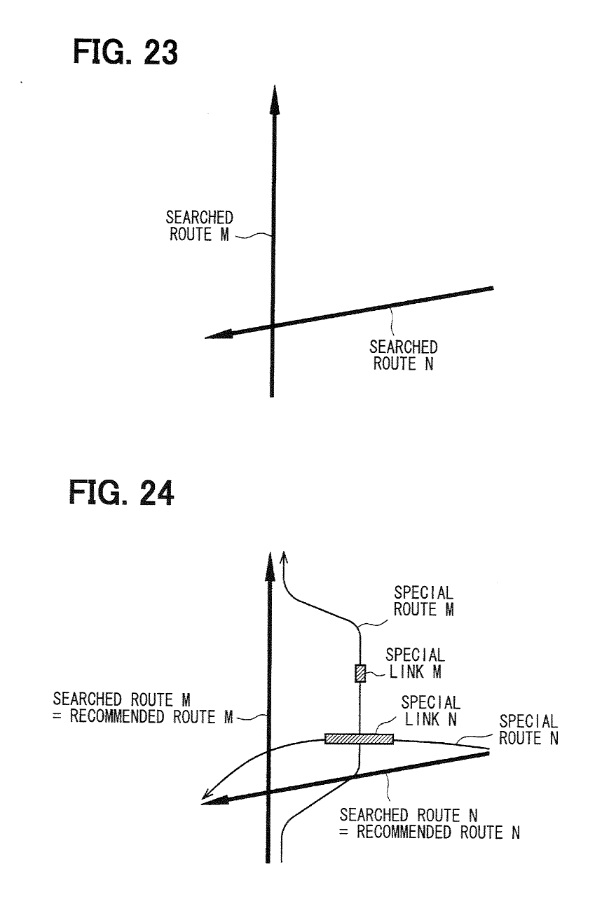

With reference to FIGS. 21 and 22, two special links may be closely positioned and may have different directions, such that the travel directions of the vehicle on the two special links differ greatly from each other. In such a situation, the center apparatus 3 stores each of the special links in a referable manner that enables an association of each of the recommended routes calculated with each of the special links that are respectively used as a basis of the calculation of the recommended routes.

For instance, by the recommended route association process, the center apparatus 3 identifies the vehicle that has passed either a special link M or a special link N. A recommended route M is calculated based on the spot information of the navigation apparatus 2 disposed in the vehicle that has passed the special link M, and the recommended route M is stored in a referable manner that associates the recommended route M with the special link M. Further, the center apparatus 3 also calculates a recommended route N based on the spot information of the navigation apparatus 2 disposed in the vehicle that has passed the special link N, and stores the recommended route N in a referable manner that associates the recommended route N with the special link N.

With reference to FIGS. 23 to 25, when a searched route M matches the recommended route M, the center apparatus 3 identifies, by the special route presentation process, a special link M that is referred to by the recommended route M that matches the searched route M, and calculates, as a special route M, a route that includes the special link M. When a searched route N matches the recommended route N, the center apparatus 3 identifies a special link N that is referred to by the recommended route N that matches the searched route N, and calculates, as a special route N, a route that includes the special link N. After receiving the special routes M and N from the center apparatus 3, the navigation apparatus 2 displays the special routes M and N together with the searched routes M and N that are searched for by the navigation apparatus 2 based on the start point and the destination.

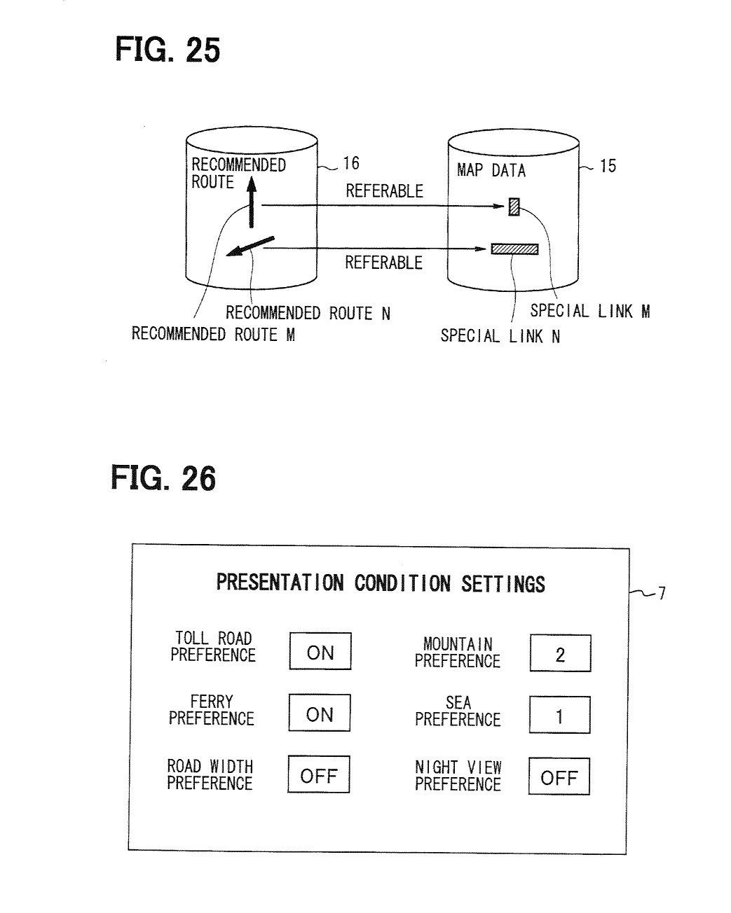

With reference to FIG. 26, the navigation apparatus 2 may display user preferences, i.e., the user condition, in a presentation condition setting screen. The center apparatus 3 may determine whether or not the special route should be presented to the user based on the user preference settings received from the navigation apparatus 2. In other words, after calculating a special route, the center apparatus 3 presents the special route calculated to the navigation apparatus 2 when the special route is in accordance with the user preference settings received from the navigation apparatus 2. That is, the special route is displayed only when the special route satisfies the user condition.

More practically, if the special route includes a toll road or a toll section, the center apparatus 3 may present such special route to the navigation apparatus 2 when a user preference setting indicates “Toll road preference ON,” and the center apparatus 3 may refrain from presenting such special route to the navigation apparatus 2 when the user preference setting indicates “Toll road preference OFF.”

Further, if a travel of the vehicle is during night, the center apparatus 3 may present the special route to the navigation apparatus 2 when a user preference setting indicates “Night view preference ON,” and the center apparatus 3 may refrain from presenting the special route to the navigation apparatus 2 when the user preference setting indicates “Night view preference OFF.”

Furthermore, the center apparatus 3 may consider traffic information that is received from a traffic information distribution server, for determining whether to present the special route to the navigation apparatus 2. In other words, after the calculation of the special route, the center apparatus 3 may present the special route to the navigation apparatus 2 when a travel of the special route does not have any difficulty. More practically, the center apparatus 3 may present the route to the navigation apparatus 2 when the special route does not have any traffic congestion or an accident. Conversely, when the special route has traffic congestion or an accident, the center apparatus 3 may refrain from presenting the special route to the navigation apparatus 2.

According to the present embodiment, the center apparatus 3 stores, in a referable manner, a special link having been passed by the navigation apparatus 2 and a recommended route that is assumed to be passed by the same navigation apparatus 2 when the navigation apparatus 2 does not pass the special link.

Upon receiving a route search request from the navigation apparatus 2, the center apparatus 3 calculates a searched route as a route between a start point and a destination that are identified by the route search request. After determining that the searched route calculated matches the recommended route, the center apparatus 3 presents, as a special route, a route that includes the special link that is associated with the recommended route that matches the searched route.

In such manner, the navigation apparatus 2 in cooperation with the center apparatus 3 can output the special route after receiving the special route that is searched for by the center apparatus 3, thereby enabling the vehicular navigation apparatus 2 to appropriately output the special route that includes the special link without preparing/storing information about the special link in the map data on the navigation apparatus 2.

Further, since only the special route that matches the user preference is presented to the navigation apparatus 2, the center apparatus 3 can avoid providing the special route to the navigation apparatus 2 when the special route is not desired by the user as a guidance route. Therefore, the special route that matches the user preference is appropriately output from the navigation apparatus 2.

Further, since the center apparatus 3 provides the special route to the navigation apparatus 2 in consideration of traffic information, the center apparatus 3 can avoid providing to the navigation apparatus 2 a route that poses travel difficulties, such as traffic congestion or an accident. Therefore, the special route is appropriately output in consideration of the traffic information.

Further, based on an association of a recommended route with special links in a 1-to-many correspondence, when a searched route matches a recommended route, more than one special routes can be presented to the navigation apparatus 2 as candidate routes that respectively include one of the special links. Therefore, more than one special route can be simultaneously provided by the navigation apparatus 2. In other words, the number of choices of the special route is increased.

Further, based on an association of recommended routes with a special link in a many-to-1 correspondence, when a searched route matches one of the recommended routes, a special route can be presented to the navigation apparatus 2 as a candidate route, where the special route is commonly associated with more than one searched routes in the navigation apparatus 2. Therefore, such special route is output in association with more than one searched routes from the navigation apparatus 2. In other words, such special route has an increased chance to be selected. That is, a special route becomes more readily picked up in the navigation system 1.

Further, based on an association of recommended routes with a special link in a many-to-many correspondence, more than one special route can be output from the navigation apparatus 2 as well as a special route that is commonly associated with more than one searched routes can also be output from the navigation apparatus 2. In other words, the number of choices of the special route is increased, and a special route becomes more readily picked up in the navigation system 1.

Further, when the navigation apparatus 2 simultaneously displays, a special route that is received from the center apparatus 3 with either a searched route that is searched for according to a normal search procedure by the navigation apparatus 2 or a searched route that is searched for according to a normal search procedure by the center apparatus 3, the searched route and the special route are displayed in a mutually distinguishable manner. Therefore, which one is a special route and which one is a searched route, i.e., which one is a valued detour route that is worth detouring, is readily understood by the user.

Although the current disclosure has been fully described in connection with the preferred embodiment thereof with reference to the accompanying drawings, it is to be noted that various changes and modifications will become apparent to those skilled in the art.

The navigation apparatus 2 in the present embodiment may not only be a vehicular navigation apparatus for use in a vehicle, but also a portable device or a portable terminal having a navigation function, which can be carried by a user, such as a cellular phone or the like. When the navigation apparatus in the present disclosure is realized as such device/terminal, the navigation apparatus in the present disclosure can be used during a walk, a run or the like, which leads to an increase of the added value of such apparatus.

The special link specified by the map data creating organization may not only be a link with a good view, but may also be, for example, a link around a sightseeing place of historic interest or other links providing an added value. By specifying, as a special link, a link having an added value (i.e., a link worth passing even by having a detour, due to a comparative advantage such as a good view or the like), the map data creating organization can present a route having an added value for the user as one of the candidate routes from among selectable routes.

The user preference may be specified as any condition including, for example, availability of a parking space, a public rest room, or parkability.

The user preference may be specified as weather condition when the navigation apparatus 2 can obtain weather information. In such a case, the navigation apparatus 2 may provide a good view special route when fine weather is predicted, which ensures a good view, and may refrain from providing a good view special route when bad weather is expected, which does not ensure a good view.

Further, when the navigation apparatus 2 outputs multiple special routes at the same time, the navigation apparatus may put a priority order for each of the multiple special routes.

When a road camera is installed on the special route, an image from such road camera may be provided by the navigation apparatus 2 together with the special route. In such manner, a view of the special route can be presented to the user in advance before the travel of such special route, providing the user with a clue for determining the suitability of the special route as a guidance route.

Such changes and modifications are to be understood as being within the scope of the current disclosure as defined by the appended claims.

What is claimed is:

1. A center apparatus comprising:
a map data storage device storing map data;
a current position acquisition unit acquiring a current position of a navigation apparatus from the navigation apparatus;
a passage determination unit determining, based on a comparison between the current position acquired by the current position acquisition unit and the map data stored in the map data storage device, whether the navigation apparatus transmitting the current position has passed a special link that satisfies a specific condition;
a spot information acquisition unit acquiring spot information from the navigation apparatus determined as having passed the special link by the passage determination unit, wherein the spot information is information that identifies travel positions of the navigation apparatus before and after the special link;
a recommended route calculation unit calculating, as a recommended route, a route including the travel positions before and after the special link and does not include the special link, wherein the recommended route is calculated based on a comparison between the spot information acquired by the spot information acquisition unit and the map data stored in the map data storage device;
an association unit associating the special link with the recommended route;
a route search request acquisition unit acquiring from the navigation apparatus a route search request, the route search request identifying the current position of the navigation apparatus and a destination;
a searched route calculation unit calculating, as a searched route, a route between the current position and the destination of the route search request acquired by the route search request acquisition unit;
a special route calculation unit calculating, as a special route, a route including the special link that is associated with the recommended route, wherein the special route is calculated based on a comparison between the searched route calculated by the searched route calculation unit and the recommended route calculated by the recommended route calculation unit when the searched route matches the recommended route; and
a special route presentation unit transmitting the special route calculated by the special route calculation unit to the navigation apparatus providing the route search request.

2. The center apparatus of claim 1 further comprising:
a user condition acquisition unit acquiring, from the navigation apparatus, a user condition identified by the navigation apparatus; and
a user condition match-determination unit determining whether the special route calculated by the special route calculation unit satisfies the user condition acquired by the user condition acquisition unit, wherein
the special route presentation unit transmits from among routes calculated by the special route calculation unit, the special route that is determined by the user condition match-determination unit as satisfying the user condition, to the navigation apparatus that provided the route search request.

3. The center apparatus of claim 1 further comprising:
a traffic information acquisition unit acquiring traffic information, wherein
the special route presentation unit transmits, from among routes calculated by the special route calculation unit, the special route that accords with the traffic information acquired by the traffic information acquisition unit, to the navigation apparatus that provided the route search request.

4. The center apparatus of claim 1, wherein
the association unit associates the special link with the recommended route in a many-to-1 correspondence.

5. The center apparatus of claim 1, wherein
the association unit associates the special link with the recommended route in a 1-to-many correspondence.

6. The center apparatus of claim 1, wherein
the association unit associates the special link with the recommended route in a many-to-many correspondence.

7. A navigation system comprising:
a navigation apparatus including a communication unit transmitting and receiving data, and a display unit; and
a center apparatus communicating with the navigation apparatus, and including:
a map data storage device storing map data,
a current position acquisition unit receiving a current position of the navigation apparatus from the navigation apparatus,
a passage determination unit determining, based on a comparison between the current position received by the current position acquisition unit and the map data stored in the map data storage device, whether the navigation apparatus transmitting the current position has passed a special link that satisfies a specific condition,
a spot information acquisition unit receiving spot information from the navigation apparatus determined as having passed the special link by the passage determination unit, wherein the spot information is information that identifies travel positions of the navigation apparatus before and after the special link,
a recommended route calculation unit calculating, as a recommended route, a route including the travel positions before and after the special link and not including the special link, wherein the recommended route is calculated based on a comparison between the spot information acquired by the spot information acquisition unit and the map data stored in the map data storage device,
an association unit associating the special link with the recommended route,
a route search request acquisition unit receiving a route search request from the navigation apparatus, the route search request identifying the current position and a destination of the navigation apparatus,
a searched route calculation unit calculating, as a searched route, a route between the current position and the destination based on the route search request,
a special route calculation unit calculating, as a special route, a route including the special link associated with the recommended route, wherein the special route is calculated based on a comparison between the searched route calculated by the searched route calculation unit and the recommended route calculated by the recommended route calculation unit when the searched route matches the recommended route, and
a special route presentation unit transmitting the special route calculated by the special route calculation unit to the navigation apparatus providing the route search request, wherein
the navigation apparatus displays the special route received from the center apparatus on the display unit.

8. The navigation system of claim 7, wherein,
the navigation apparatus simultaneously displays the searched route and the special route in a mutually-distinguishing manner on the display unit when the navigation apparatus calculates the searched route and receives the special route from the center apparatus.

9. The center apparatus of claim 7, wherein
the navigation apparatus simultaneously displays the searched route and the special route in a mutually-distinguishing manner on the display unit when the center apparatus transmits both the searched route calculated therein and the special route.
